(19) United States
(12) Patent Application Publication
(10) Pub. No.: US 2024/0351095 A1
(43) Pub. Date: Oct. 24, 2024

(54) Method and Apparatus for Chain Welding

(71) Applicant: PEWAG engineering GmbH, Kapfenberg (AT)

(72) Inventors: Oliver Tobin, Ollern (AT); Markus Scheibner, Eisbach (AT)

(21) Appl. No.: 18/659,081

(22) Filed: May 9, 2024

(30) Foreign Application Priority Data
Mar. 9, 2023 (EP) 23160993.4

(51) Int. Cl. B21L 3/02; B23K 37/04; B23K 101/30

(52) U.S. Cl. CPC B21L 3/02; B23K 37/0426; B23K 2101/30

(57) ABSTRACT

A method and an apparatus for chain welding a chain starting from a chain composed of open C-shaped chain links uses a conveying wheel which receives one or more chain links of the chain and positions them for welding. The conveying wheel is a double chain wheel, the two pocket wheels of which receive a respective chain link of two chain strands of the chain. In each sequence of welding of a chain link, the conveying wheel is displaced relative to a welding device transversely with respect to the longitudinal direction of the chain and then occupies a welding position in which a chain link to be welded, as chain link that is vertical in the conveying wheel, faces the welding device and the open ends thereof are welded. This sequence is repeated, allowing that chain links of the two chain strands are alternately welded in the chain wheel.

The invention relates to a method and an apparatus for chain welding. Therein, a chain composed of interlocked chain links is produced starting from a non-welded chain; the chain in the non-welded state is formed from a plurality of open chain links which each have the form of an extruded piece shaped into an open ring (the shape of a C), the open ends of which face one another; said chain links are joined together (interlocked) to form a continuous chain, respectively successive chain links being rotated by an angle of substantially 90° relative to one another. In conventional methods for chain welding, one of two known procedures is used in principle. In a first approach, the non-welded chain is turned after each welding operation. For this purpose, a device referred to as a chain turner is used. The non-welded chain lies in a guide which rotates after each operation of welding a chain link. This allows the two chain rows (left-hand and right-hand link row) to be welded directly one after the other in the machine. A second approach is somewhat simpler insofar as the chain is welded completely at the horizontal chain links in a first pass and subsequently at the vertical chain links in a second pass. The entire chain therefore has to be guided through the welding machine twice; as an alternative, two chain-welding machines lined up one behind the other are used, and therefore the chain is welded in one pass, in order to reduce the throughput time.

The mentioned approaches are laborious and—particularly with regard to the chain turner—complex. There is therefore the need for a more efficient handling of the chain for the welding of the chain links of the two orientations.

The mentioned object is achieved according to the invention by a method for chain welding of the type mentioned in the introduction, in which a conveying wheel, in which at least one of the chain links of the chain is temporarily accommodated in order to guide the chain, is used to perform the following steps:
relative displacing of the conveying wheel in relation to a welding device transversely with respect to the longitudinal direction of the chain guided in the conveying wheel, so as to occupy a welding position in which a chain link to be welded has a position as vertical chain link in the conveying wheel with its open ends facing the welding device (and thus suitable for the welding processing),
welding of the open ends of the chain link to be welded by means of the welding device,
relative displacing of the conveying wheel and of the welding device transversely with respect to the longitudinal direction of the chain guided in the conveying wheel out of the welding position (and typically into a transporting position which allows the chain to be conveyed in the longitudinal direction thereof without impeding or being impeded by the welding device),
rotation of the conveying wheel in order to convey the chain, as a result of which a next chain link to be welded arrives at the position of the chain link that has just been welded, the above steps being repeated for each of a plurality of chain links to be welded of the chain.

The invention thus provides a technical solution for a chain-welding process, in which the individual chain links are guided over a chain wheel in the form of a pocket wheel and are brought into the welding position by means of the chain wheel in the machine. The chain can also be advanced cyclically by means of the chain wheel. By means of the chain wheel, the invention makes it possible to feed the differently aligned chain links to the welding process in their respective positions, i.e. vertical and horizontal, such that they can be welded in their respective position.

The invention makes it possible to achieve a plurality of advantages. In particular, the welding process for the vertical and the horizontal chain links takes place in one tool (i.e. the same apparatus). There is also a reduced susceptibility to soiling, with a self-cleaning effect as a result of the rotational movements, and a long service life of the chain wheel with low mechanical loading of the chain.

The invention also results in advantages during the guiding and transporting of the chain. There is a more rapid sequence with increased reliability, the guiding of the chain can be ensured by components in the chain-welding apparatus itself, avoiding external drive components, and the chain links to be welded can be (pre-) positioned directly at the site of the welding.

The conveying wheel used may advantageously be a pocket wheel. As a result, a particularly stable mounting of the chain links during the welding of the individual links and the conveying of the chain is achieved. The pocket wheel may preferably be embodied in such a way that it has, in a circumferential direction, pockets for accommodating horizontal links and a groove, running in the circumferential direction, for accommodating vertical links. Pocket wheels are known per se and constitute tried and tested means for holding and conveying link chains. As an alternative, the conveying wheel may also be embodied differently, for example as a toothed wheel or other known wheel types.

It is particularly advantageous for the conveying wheel used to be a double chain wheel with two (or more) chain wheels, in particular pocket wheels, arranged next to one another. In this favorable development, the chain may be guided around the conveying wheel twice, namely around each of the two chain wheels so as to form a chain loop between them, a rotation of the chain in the longitudinal direction being effected in the chain loop, resulting in chain links that are horizontal on a first of the chain wheels being guided as chain links that are vertical on the second of the chain wheels.

In this case, more efficient performance of the welding operations of the two chain link rows can also be achieved if the vertical chain links in the two chain wheels, as chain links to be welded, are welded directly one after the other in the welding position, the conveying wheel being displaced relative to the welding device preferably along the axis of rotation of the conveying wheel between these two welding operations, in order to change between positions of the two chain links, said positions being suitable for the welding processing. The conveying wheel and the welding device may expediently be temporarily relatively displaced out of the welding position, preferably transversely with respect to the longitudinal direction of the chain guided in the conveying wheel, for performance of the relative displacement between the two welding operations. In this case, it is also advantageous for the pockets of the pocket wheels arranged next to one another to be arranged angularly offset relative to one another.

This also results in an advantage that neighboring links in a chain strand are not welded directly one after the other, but rather only after the chain loop between the two chain tracks of the various chain wheels has been passed through. This results in a reduction in the heat influence and asymmetrical loading of the chain links is avoided.

An alternative simplified welding method may provide for the chain to be welded in two passes, namely in a first pass, in which a first number of chain links corresponding to chain links that are vertical on the conveying wheel are welded, and, after rotation of the chain, which brings chain links that are horizontal on the conveying wheel into a vertical position, in a second pass, in which a second number of chain links corresponding to chain links that are horizontal on the conveying wheel during the first pass (and are now vertical) are welded. According to a further alternative procedure for the welding method, provision may be made for the chain to be welded using (at least) two welding devices and (at least) two conveying wheels, which are each assigned to one of the welding devices. Here, a number of first chain links, which are chain links that are vertical on a first conveying wheel, may be welded by a first of these welding devices on the conveying wheel, and a number of second chain links may be welded by a second of these welding devices on a second conveying wheel, the second chain links corresponding to chain links that are horizontal on the first conveying wheel (and vertical on the second wheel), the chain preferably being rotated, in the sense of a rotation about the longitudinal direction, between the first and the second conveying wheel.

The (horizontal) chain link that directly follows the chain link that has just been welded may favorably be skipped when the conveying wheel is rotated in order to convey the chain.

The aforementioned object is also achieved by an apparatus for chain welding a chain composed of interlocked chain links, comprising a welding device for welding the open ends of a chain link to be welded in order to produce a closed chain link, and comprising a conveying wheel designed to guide the chain in order to accommodate at least one of the chain links of the chain, the conveying wheel and the welding device being able to be displaced relative to one another between a welding position and a transporting position transversely with respect to the longitudinal direction of the chain guided in the conveying wheel, and, in the welding position, the open ends of a chain link to be welded protruding from the conveying wheel and being led to a welding device, in order to enable welding of the chain link to be welded by means of the welding device. In the transporting position, the chain is preferably able to be conveyed in the longitudinal direction thereof without impeding or being impeded by the welding device.

The preferences of this technical solution of a chain-welding apparatus correspond to those of the method according to the invention presented above. In the case of the chain-welding apparatus according to the invention, it is also generally advantageous for the welding device to be mounted in a positionally fixed manner and the conveying wheel, including the at least one chain link accommodated therein, to be able to be displaced transversely with respect to the longitudinal direction of the chain, for example in the vertical direction.

It is particularly advantageous for the conveying wheel to be a double chain wheel with two (or more) chain wheels arranged next to one another, as has already been discussed in connection with the method according to the invention. Furthermore, more efficient and at the same time reliable performance of the welding operations of the two chain link rows can be achieved if the welding device is also able to be displaced relative to the conveying wheel along the axis of rotation of the conveying wheel, in particular between two positions that are suitable for the welding processing of the two vertical chain links on the two chain wheels.

Furthermore, a construction that is safer against overloading can be obtained if sprung torque supports are provided in the apparatus, which guide the chain during the feeding to the chain-conveying wheel and/or the discharging from the chain-conveying wheel.

The invention will be explained in more detail below on the basis of an exemplary embodiment which is illustrated in the attached drawings. It goes without saying that the exemplary embodiment is merely exemplary and should not be interpreted as limiting for the invention. The drawings show:

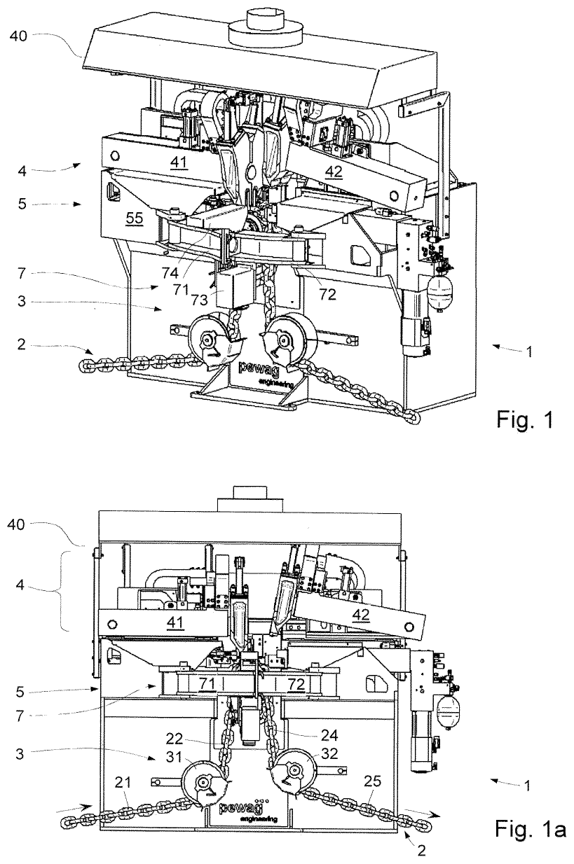

FIG. 1 a perspective view of an apparatus for chain welding a chain according to the exemplary embodiment, with chain inserted therein;

FIG. 1a a front view of the chain-welding apparatus in FIG. 1;

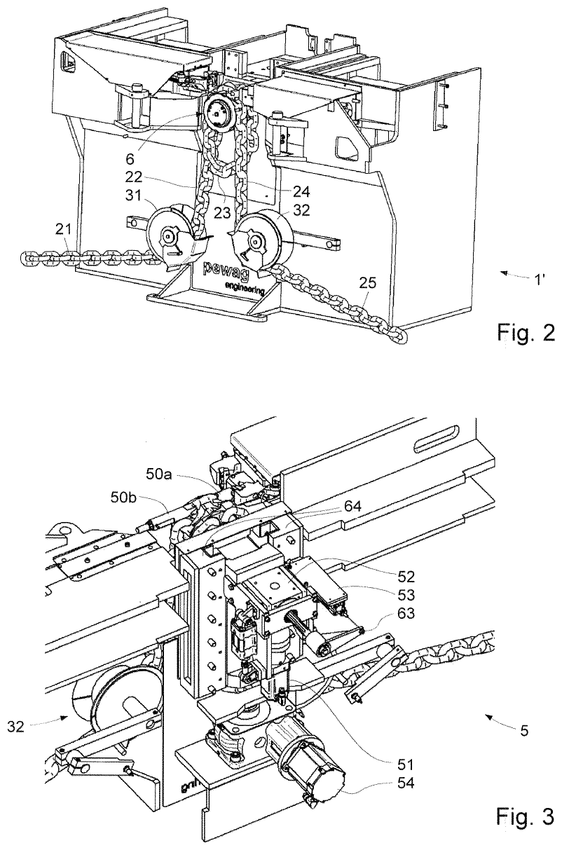

FIG. 2 a perspective view of the chain-welding apparatus in FIG. 1 with the welding device removed;

FIG. 3 a perspective partial rear view of the apparatus in FIG. 1;

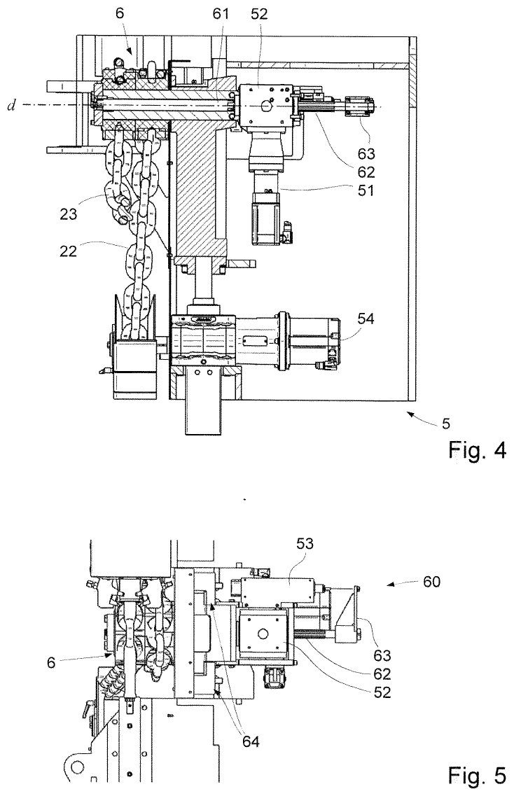

FIG. 4 a sectional view of the chain-welding apparatus in FIG. 1 with the welding device removed, along a section plane along a perpendicular plane through the axis of the chain-conveying wheel;

FIG. 5 a detail in plan view of the middle region of the chain-welding apparatus with the welding device removed;

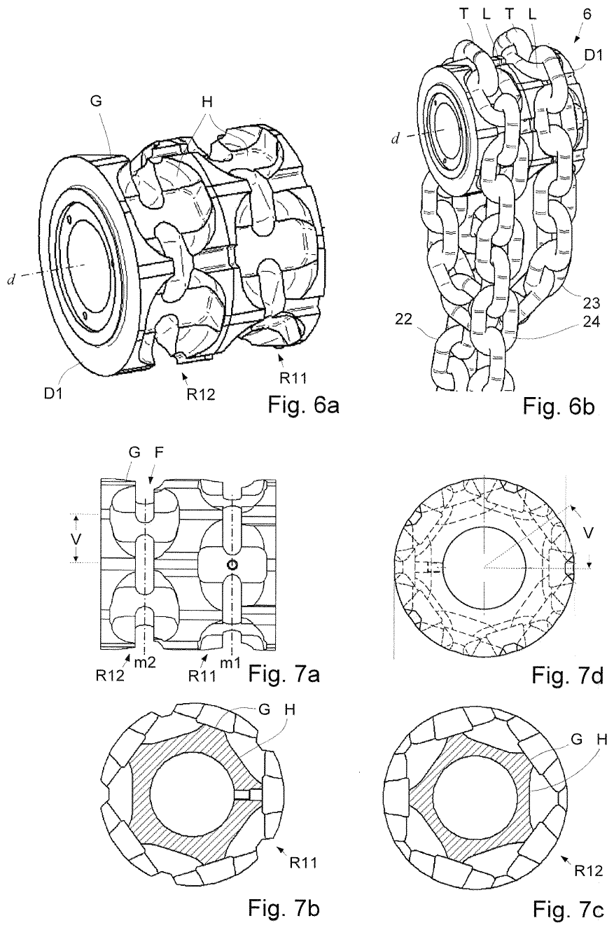

FIG. 6a the chain-conveying wheel according to the exemplary embodiment in a perspective view without the chain;

FIG. 6b the chain-conveying wheel with placed-on chain;

FIGS. 7a-7d the chain-conveying wheel in further views, namely FIG. 7a a side view, FIG. 7b a sectional view through the center plane m1 of the first pocket wheel, FIG. 7c a sectional view through the center plane m2 of the second pocket wheel, FIG. 7d a front view (end face); and

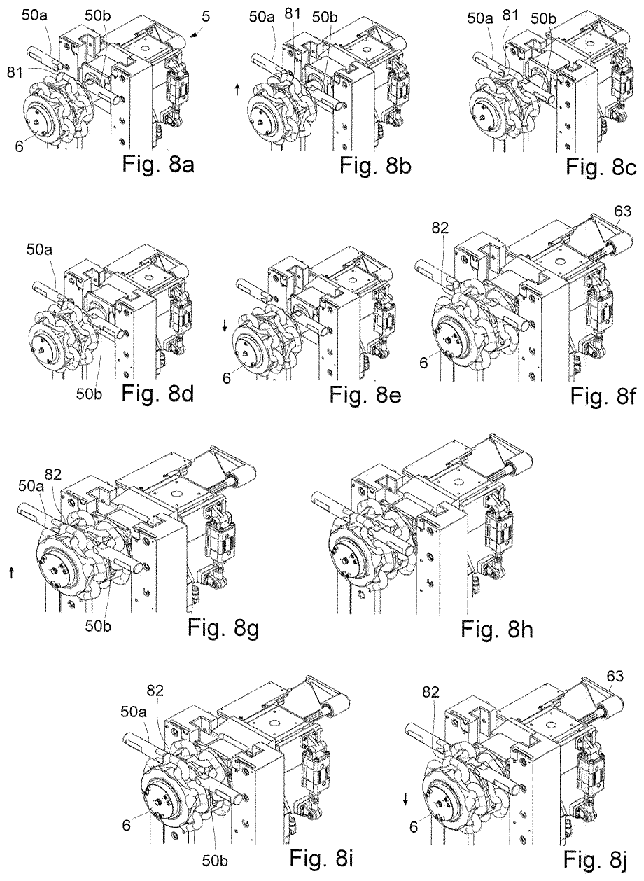

FIGS. 8a-8j illustrate the sequence of a pass of a welding process in the apparatus in FIG. 1.

The detailed description of the exemplary embodiment explains the ideas underlying the invention, the embodiment thereof and further preferences and configurations. It goes without saying that, wherever different variants are specified, all of these variants or individual ones can be freely combined with one another, insofar as this is apparent as expedient to those skilled in the art. Terms such as “advantageously”, “by way of example”, “typically” or “preferably” indicate elements or measures that are particularly favorable but not essential for the invention or an exemplary embodiment; these may still be modified, if this is considered expedient by those skilled in the art, provided that these are not expressly designated as essential. Terms designating orientations such as “perpendicularly” or “horizontally” relate to the state of the chain-welding apparatus in the operating state thereof (cf. FIGS. 1-6). It should also be appreciated that the invention is not limited to the embodiment(s) discussed below, but rather the discussion of the embodiments serves to explain the invention and show possible configurations.

FIGS. 1 and 1a show a chain-welding apparatus 1 according to an exemplary embodiment of the invention in a perspective view and a view from the front, respectively. The chain-welding apparatus 1 is illustrated with chain 2 inserted therein and comprises a guide system 3 for the chain, a welding device 4 including an extractor hood 40, a drive mechanism 5, a conveying wheel 6 and a front cover 7. FIGS. 2 to 5 illustrate the opened-up chain-welding apparatus 1′ in a state with the welding device 4 and the front cover 7 removed.

As can be seen in the figures, the chain 2 to be welded is guided over a conveying wheel 6. The conveying wheel 6 serves to position and convey the chain to be welded; it is therefore also referred to as chain-conveying wheel. As also shown in FIGS. 6a and 6b, the chain-conveying wheel is preferably embodied as a double pocket wheel D1.

The guide system 3 includes, in particular, two guide rollers 31, 32 which serve to guide the chain 2, namely to guide the incoming strand 22 from the fed chain region 21 for the purpose of feeding to the chain-conveying wheel 6 and the outgoing strand 24 of the finally welded chain region 25 for the purpose of discharging from the chain-conveying wheel 6. In this document, “chain strands” or “strands” for short, according to customary terminology, refer to the portions of the chain that are each subjected to a certain tensile force. At the same time, the guide system 3, by means of the guide rollers 31, 32 which are embodied as sprung torque supports fastened for example to the housing of the apparatus 1 via articulated connections, ensures a preload of the chain strands 22, 24 toward and from, respectively, the conveying wheel.

The welding device 4 is designed, in a manner known per se, as a flash butt welding device, but may also be embodied as a device for other types of welding methods, in particular resistance press welding methods. FIGS. 1 and 1a illustrate one of the two welding arms 41, 42 in a raised position, for better visibility of the conveying wheel 6 in the apparatus 1; however, it is of course clear that both welding arms are positioned level during the work process.

The drive mechanism 5 comprises components for driving the conveying wheel 6 for the rotational movement and displacement movement in preferably two directions (vertically and parallel to the axis of rotation) as explained below. Furthermore, holding devices (having what are known as upsetting dies 50a, 50b) for firmly holding and compressing chain links, which are positioned on the conveying wheel, during the welding operation are provided.

Referring in particular to FIGS. 4-6, the drive mechanism 5 rotates and displaces the conveying wheel 6 by means of suitable electric motor or servomotors:

An advancing drive 51 is provided for rotating the conveying wheel 6 (forward feed), for example in the form of an electric motor which drives the shaft 61 of the conveying wheel 6 for rotation, for example by means of a bevel gearbox 52 (for example in the form of a gearbox assembly, for example from Tandler FS2 HWK, pre-mounted in a dedicated housing) which cooperates with a splined shaft portion 62 of the shaft 61 which runs through the bevel gearbox 52.

A displacement drive 53 is configured to displace the position of the conveying wheel 6 along its axis of rotation d. The displacement drive 53 is for example a servomotor which is arranged to the side of the bevel gearbox 52 and acts on an end of the shaft 61 via a connecting piece 63. The offset width of the spindle motor can be fixedly pre-set to a distance that corresponds to the relative offset between the two chain wheels (distance between the center planes m1, m2, see FIG. 7a).

The two drives 51, 53 may advantageously be combined to form an assembly 60, which also comprises the shaft 61 together with the conveying wheel 6 fastened thereto. The assembly 60 is held in a linear guide 64 (for example slide bearing), which enables a vertical movement of the assembly 60.

A lifting drive 54, for example in the form of a screw jack, is for the horizontal moving of the conveying wheel 6. To this end, the assembly 60 is moved by the lifting drive. The vertical position is monitored via detectors provided in the linear guide 64; as an alternative, the lifting drive may also have a stepper motor function.

Provided in a manner known per se on both sides of the position of the conveying wheel 6 are holding devices 55 in particular including what are known as upsetting dies 50a, 50b which are used to hold the chain links to be welded in their position on the conveying wheel and to press them together during a welding operation. No motor operation takes place during a welding operation, rather the chain links are moved only between the welding operations.

Again referring to FIG. 1, the front cover 7 contains two brackets 71, 72, which span the front side of the conveying wheel 6 and contribute to the machine rigidity, and splash guard parts 73, 74 attached thereto below and above the middle parts of the brackets 71, 72. The brackets 71, 72 are mounted in an articulated manner on the housing of the holding devices 55 and can be folded out, for example for inserting the chain 2 onto the conveying wheel 6 at the beginning of a welding pass.

As can be seen in particular in FIG. 2 and FIG. 6b, the chain is guided over the double pocket wheel 6 twice. In the apparatus, the chain thus runs along two strands, namely an incoming strand 22 and an outgoing strand 24, and, between these two strands, an idle strand, referred to as chain loop 23, below the conveying wheel; the strands 22, 23, 24 transition into one another on the conveying wheel. In the chain loop, the chain is rotated through 90°. This makes it possible, as explained in detail below, to weld both link rows (of the vertical and horizontal chain links) in one process.

Referring to FIGS. 6a, 6b and 7a-7d, the chain-conveying wheel 6 is embodied as a double chain wheel D1 formed from two chain wheels R11, R12. Preferably, the two pocket wheels R11, R12 are not embodied as separate components, but rather both pocket wheels form one component, such that the conveying wheel 6 is in one piece as in the embodiment shown. In other embodiments (not shown), the double chain wheel may have been rotationally fixedly composed of two separate chain wheels, for example by a plug-in connection, screw connection or adhesive connection.

Each of the chain wheels R11, R12 is designed as what is known as a pocket chain wheel. It therefore has pockets H which are adapted to the oval link shape and have a substantially planar bearing surface (pocket bottom) for a horizontal chain link L. The pockets of the chain wheel are delimited in relation to one another by webs G, each web being interrupted by a groove F for accommodating the vertical links T in the center plane m1, m2 of the chain wheel R11, R12. In the present exemplary embodiment, the chain wheel has, in the side view, a pentagonal shaping (n=5), with five pockets H and accordingly five webs G delimiting said pockets in relation to one another; it is nevertheless clear that a chain wheel can readily also have a greater or smaller number n of pockets and webs. The webs G have convex flanks which transition, at their “inner” edge (that is to say the edge nearest the axis of rotation d), directly into the planar bearing surfaces of the pockets H. In the preferably flat bottom of the grooves F for the vertical links T, the vertical links T can be supported on the groove bottom of the groove F such that a correct position of the links is ensured. Due to this design of the chain wheel, both the horizontal links L and the vertical links T are flat supported at large areas, namely the horizontal links L with a large part of their side surfaces on the bearing surface of the pockets and the vertical links T with the outer surface of the internal limb on the groove bottom.

In the double chain wheel D1, the two chain wheels R11, R12 are coaxially rotationally fixedly connected to one another next to one another.

Advantageously, the chain wheels have an angular offset relative to one another, that is to say the chain pockets of the one chain wheel R11 are at a different angular position relative to the chain pockets of the other chain wheel R12, as seen along the axis of rotation d. This can synonymously also relate to the webs 10) G, that is to say the webs G of the one chain wheel R11 are at a different angular position relative to the webs G of the other chain wheel R12, when looking along the axis of rotation d. In the embodiment shown, this angular offset V is an angular pitch of the chain on the pentagonal chain wheel (corresponding to 360°/2n=36° where n=5); this means that the horizontal chain links of the one chain wheel are aligned at an identical angular position with the vertical chain links of the other chain wheel, and vice versa.

The angular pitch can be seen on a chain wheel as the angular difference between a chain pocket H and one of the two webs G which delimit this chain pocket, measured for example on the basis of the radial lines running through the center of the chain pocket and of the web (cf. FIG. 7d). This means the angular pitch is half the angular difference between two successive chain pockets H (or webs G) of the same chain wheel; as a result, two successive chain links T, L on the chain wheel also have an angular distance from one another that corresponds to the angular pitch.

Overall, for both chain strands guided over the double chain wheel, the individual chain links are alternately held vertically T and horizontally L on the respective chain wheel R11, R12 and are thus guided in a respective “chain track”.

As an alternative to the exemplary embodiment shown, in particular in the case that the conveying wheel is designed as a single pocket wheel, the chain could also be guided through a welding installation in two passes using such a single conveying wheel, the chain running over the pocket wheel and the first link row being welded in the first pass. In the second pass through the machine, the chain—rotated through 90° beforehand—is once again guided over the pocket wheel and the second link row is welded.

Referring to FIGS. 8a to 8j, an exemplary configuration of the welding process is explained below, which is explained on the basis of the apparatus in FIGS. 1-7. In the course of a welding process, the conveying wheel 6 is moved up and down, and back and forth, by means of the drive mechanism 5, in order to suitably position the chain 2 for the chain-welding process. FIGS. 8a to 8j show the individual process steps explained below. For the sake of clarity of the illustration, FIGS. 8a□8j illustrate only the essential components, namely the conveying wheel 6, the chain links arranged on said conveying wheel, the upper part of the drive mechanism 5 and the upsetting dies 50a, 50b (without their holders); the remaining appropriate components of the chain-welding apparatus can be deduced from the rest of the disclosure by those skilled in the art.

The process explained below assumes that the chain 2 is inserted into the apparatus 1 in such a way that the chain first runs over the rear pocket wheel of the double chain wheel 6 and then—after the chain loop 23, which is not illustrated in the drawings in FIGS. 8a-8j, has been passed through—is guided over the front pocket wheel. It goes without saying that the order can also be reversed, depending on the desired welding process. The starting point of the step sequence illustrated below (that is to say directly before step 1) is a position of conveying wheel and chain in which the conveying wheel is below the welding device 4, in a position in which the rear pocket wheel is aligned with the welding device (that is to say in a common vertical plane in relation to the welding electrodes), and preferably below the welding device at a distance therefrom, enabling unimpeded rotational movement of the conveying wheel with the chain placed therein, but also insertion of the chain (and subsequently removal of the chain), without being impeded by the components of the welding device or any damage to the latter or the chain links being incurred.

Step 1—FIG. 8a: The conveying wheel performs a suitable rotation, this conveys the chain 2 into a position that gives rise to a pre-positioning for the optimal welding position, a vertical chain link 81 being oriented facing the welding device 4. If necessary, a positioning along the axis of rotation of the conveying wheel also takes place (cf. in this respect step 11).

Step 2—FIG. 8b: In the second step, the chain-conveying wheel 6 is displaced upward by means of the drive mechanism 5, such that the chain link 81 is located between the two upsetting dies 50a, 50b.

Step 3—FIG. 8c: The upsetting dies 50a, 50b are driven towards the chain link onto the chain link 81 located in the welding position, such that they clamp the (still C-shaped) chain link to be welded. Depending on the process requirements, the upsetting dies may also be driven further together until the two chain link ends touch. The chain link is then welded to form a closed chain link in a manner known per se by means of the welding device 4 (not shown in the figure; see FIG. 1). The welding process is, for example, a flash butt welding process, but another expedient welding method, in particular resistance press welding method, may also be used.

Step 4—FIG. 8d: After welding is completed, the upsetting dies 50a, 50b are driven apart again, into their starting position (cf. FIG. 8b), and thus away from the chain link. This releases the chain link that has just been welded.

Step 5—FIG. 8e: The chain-conveying wheel 6 is moved downward. It is thus in a position corresponding to the one in FIG. 8a again.

Step 6—FIG. 8f: The conveying wheel is rotated further through an angle corresponding to a chain pitch; this brings the next vertical chain link 82 to be welded, which is, however, located on the other pocket wheel, into a position in which it is oriented facing the welding device 4. In the same step, a displacement along the axis of rotation by an offset width corresponding to the distance between the two chain link rows next to one another on the chain-conveying wheel 6 is effected; this effects a change between the two strands (chain wheel track change). In the exemplary embodiment shown, this corresponds to a linear displacement of the conveying wheel downward. Whether the displacement and rotation of the conveying wheel are carried out at the same time or one after the other is not essential for the invention, in the exemplary embodiment shown here first the displacement and then the rotation takes place (the intermediate state is not illustrated in the drawings).

Step 7—FIG. 8g: The chain-conveying wheel is displaced upward by means of the drive mechanism 5, such that the chain link 82 is located between the two upsetting dies 50a, 50b. This corresponds to step 2, only on the other chain wheel track, that is to say the front pocket wheel.

Step 8—FIG. 8h: The upsetting dies 50a, 50b are driven toward the chain link onto the chain link 82 and then the chain link is welded to form a closed chain link. This step corresponds to step 3, and what is stated regarding step 3 analogously applies.

Step 9—FIG. 8i: After welding is completed, the upsetting dies 50a, 50b are driven apart again and pass into their starting position (cf. FIGS. 8b and 8g). This releases the chain link 82 that has just been welded.

Step 10—FIG. 8j: The chain-conveying wheel 6 is moved downward. It is thus in a position corresponding to the one in FIG. 8f again.

Step 11—FIG. 8a: The conveying wheel performs a further rotation through an angle corresponding to a chain pitch; this brings the next vertical chain link to be welded on the now again rear pocket wheel into a position facing the welding device 4. In the same step (for example directly beforehand), a displacement along the axis of rotation by a distance opposite to the displacement in step 8f is effected (chain wheel track change). In the exemplary embodiment shown, this corresponds to a displacement of the conveying wheel forward.

With step 11, the same positioning of the conveying wheel as in FIG. 8a is achieved; the chain has merely been guided onward by a full double pitch. For these next chain links, the chain-welding process is continued with FIG. 8b and so on.

A forward feed of the chain thus takes place for the entire chain, in particular for the chain strands 22, 23, 24, in the steps in which the chain-conveying wheel 6 is rotated, thus
step 1=step 11 and step 6.

It goes without saying that the invention is not limited to the exemplary embodiment that has just been illustrated. For example, use may also be made of a double chain wheel in which the two chain wheels have a different angular offset or no angular offset. In this case, the forward-feed angles of the rotations have to be correspondingly adapted in a welding process; apart from that, the welding process can proceed as illustrated above. Particularly in the case of a double chain wheel without an angular offset, the chain pockets of the two chain wheels lie at the same angular position as seen along the axis of rotation of the double chain wheel. In this case, the two vertical links of both chain wheel tracks can be welded directly one after the other; this would correspond to an operation which is modified in relation to FIGS. 8a-8j and in which the rotation is omitted in step 6, while the rotation in step 11 carries out a forward feed movement through an angle corresponding to a double chain pitch.

1. A method for chain welding a chain composed of interlocked chain links, starting from a non-welded chain formed from a plurality of open chain links which each have the of a piece of strand shaped into the shape of a C, the open ends of which face one another, and are joined together to form a continuous chain, wherein respectively successive chain links are rotated relative to each other by an angle of substantially 90°,
the method using a conveying wheel, which temporarily receives at least one of the chain links of the chain in order to guide the chain, and comprising the following steps:
relative displacing of the conveying wheel in relation to a welding device transversely with respect to the longitudinal direction of the chain guided in the conveying wheel, in order to occupy a welding position in which the open ends of a chain link to be welded, as chain link that is vertical in the conveying wheel, occupy a position facing the welding device,
welding of the open ends of the chain link to be welded by means of the welding device,
relative displacing of the conveying wheel and of the welding device transversely with respect to the longitudinal direction of the chain guided in the conveying wheel out of the welding position,
rotation of the conveying wheel in order to convey the chain, as a result of which a next chain link to be welded arrives at the position of the chain link that has just been welded,
the above steps being repeated for each of a plurality of chain links to be welded of the chain.

2. The method of claim 1, the conveying wheel used being a pocket wheel.

3. The method of claim 2, the pocket wheel having, in a circumferential direction, pockets for receiving horizontal links and a groove, running in the circumferential direction, for receiving vertical links.

4. The method of claim 1, wherein the conveying wheel used being is a double chain wheel with two chain wheels arranged next to one another, the chain being guided around the conveying wheel twice, namely around each of the two chain wheels so as to form a chain loop between them, a rotation of the chain in the longitudinal direction being effected in the chain loop, resulting in chain links that are horizontal on a first of the chain wheels being guided as chain links that are vertical on the second of the chain wheels.

5. The method of claim 4, the vertical chain links in the two chain wheels being welded, as chain links to be welded, directly one after the other in the welding position, the conveying wheel being displaced relative to the welding device preferably along the axis of rotation of the conveying wheel between these two welding operations, in order to change between positions of the two chain links, said positions being suitable for the welding processing.

6. The method of claim 5, the conveying wheel and the welding device being temporarily relatively displaced out of the welding position, preferably transversely with respect to the longitudinal direction of the chain guided in the conveying wheel, for performance of the relative displacement between the two welding operations.

7. The method of claim 1, the chain being welded in two passes, namely in a first pass, in which a first number of chain links corresponding to chain links that are vertical on the conveying wheel are welded, and, after rotation of the chain, which brings chain links that are horizontal on the conveying wheel into a vertical position, in a second pass, in which a second number of chain links corresponding to chain links that are horizontal on the conveying wheel during the first pass are welded.

8. The method of claim 1, the chain link that directly follows the chain link that has just been welded being skipped when the conveying wheel is rotated in order to convey the chain.

9. The method of claim 1, the chain being welded using two welding devices and two conveying wheels, which are each assigned to one of the welding devices, a number of first chain links, which are chain links that are vertical on a first conveying wheel, being welded by a first of these welding devices on the conveying wheel, and a number of second chain links being welded by a second of these welding devices on a second conveying wheel, the second chain links corresponding to chain links that are horizontal on the first conveying wheel, the chain preferably being rotated, in the sense of a rotation about the longitudinal direction, between the first and the second conveying wheel.

10. An apparatus for chain welding a chain composed of interlocked chain links, starting from a non-welded chain formed from a plurality of open chain links which each have the form of a piece of strand shaped into the shape of a C, the open ends of which face one another, and are joined together to form a continuous chain, wherein respectively successive chain links are rotated relative to each other by an angle of substantially 90°,
comprising a welding device configured to weld the open ends of a chain link to be welded in order to produce a closed chain link, and
comprising a conveying wheel designed to accommodate at least one of the chain links of the chain in order to guide the chain,
the conveying wheel and the welding device being configured to be displaced relative to one another between a welding position and a transporting position transversely with respect to the longitudinal direction of the chain guided in the conveying wheel,
in the welding position, the open ends of a chain link to be welded protruding from the conveying wheel and being led to a welding device, in order to enable welding of the chain link to be welded by means of the welding device,
in the transporting position, the chain being able to be conveyed in the longitudinal direction thereof without impeding or being impeded by the welding device.

11. The apparatus of claim 10, the conveying wheel being a double chain wheel with two chain wheels arranged next to one another, provision being made for the chain to be guided around the conveying wheel twice, with a rotation of the chain in the longitudinal direction between these two revolutions, resulting in chain links that are horizontal on a first of the chain wheels being guided as chain links that are vertical on the second of the chain wheels.

12. The apparatus of claim 11, the welding device displaceable relative to the conveying wheel and along the axis of rotation of the conveying wheel between two positions that are suitable for the welding processing of the two vertical chain links on the two chain wheels.

13. The apparatus of claim 11, the positions provided for the horizontal chain links being arranged angularly offset relative to one another in the chain wheels that are arranged next to one another.

14. The apparatus of claim 11, at least one sprung torque support also being provided, which guides the chain during the feeding to the chain-conveying wheel and/or the discharging from the chain-conveying wheel.

15. The apparatus of claim 10, the welding device being mounted in a positionally fixed manner and the conveying wheel, including the at least one chain link received therein, being configured to be displaced transversely with respect to the longitudinal direction of the chain.

16. The apparatus of any one of claims 10 to 15 claim 10, the conveying wheel being designed as a pocket wheel.

17. The apparatus of claim 16, the pocket wheel having, in a circumferential direction, pockets for receiving horizontal links and a groove, running in the circumferential direction, for receiving vertical links.
